(19) United States
(12) Patent Application Publication
(10) Pub. No.: US 2004/0001221 A1
(43) Pub. Date: Jan. 1, 2004

(54) Method and apparatus for a variable packet rate modem or facsimile communication over a packet switched network

(76) Inventor: Ian D. McCallum, Barrie (CA)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/187,126

(22) Filed: Jun. 28, 2002

(51) Int. Cl. G06F 15/00; H04N 1/32

(52) U.S. Cl. 358/1.15; 358/468

(57) ABSTRACT

A method and apparatus for optimizing bandwidth while sending modulated signals over packet switched networks. Variable packet rates provide the benefit of reduced overhead where allowed and adherence to timing requirements where needed. Certain or all high speed modulated data in a modem communication can be sent at a slower packet rate over a packet switched network, which in turn reduces the percentage of overhead per data where beneficial.

### TECHNICAL FIELD

Embodiments of the invention relate generally to sending a modulated signal over packet switched networks using a variable packet rate and, more particularly, to a method for optimizing bandwidth in facsimile over Internet Protocol by using a variable packet rate.

### BACKGROUND

A facsimile (“fax”) transmission can be broken down into three types of signaling events: tone and signal detection events, low speed modulated data events (fax protocol negotiations), and high speed modulated data events (fax image transfer). The tone and signal detection events simply alert that a fax transmission is beginning. The low speed modulated data events help fax machines determine compatibilities as well as help set transmission parameters such as the modulation rate. Low speed modulated data events currently occur at a transmission rate of 300 bits per second (“bps”). The high speed modulated data events allow fax machines to prepare (training check field or “TCF” transmission) for the fax image transfer as well as to transfer the fax image. High speed modulated data is typically transferred at 14400 bps (1800 octets per second), although other transmission speeds are well known to those skilled in the art.

Facsimile, modem and voice transmission over an Internet Protocol (IP) network is made possible by demodulating or digitizing the fax, modem or voice signal and then transferring IP packets containing modem “events”. A “gateway” converts from modulated signals to IP packets containing events, and vice versa. To send a facsimile over Internet Protocol (“FoIP”) communication therefore requires a gateway for the sending fax machine and a gateway for the receiving fax machine. The sending fax machine communicates with a gateway, which in turn establishes communication over the packet switched network with another gateway, which in turn services the receiving fax. A fax-enabled device may be substituted for the gateway and fax machine as well.

FoIP is an umbrella term that involves multiple methods of sending a fax over an IP network, including sending fax data as Transmission Control Protocol (TCP) in IP packets or in User Datagram Protocol (UDP) packets over an IP network. UDP packets in their most basic form lack error recovery capabilities that are included in TCP, so UDP Transport Layer (UDPTL) packets, which have error recovery or redundancy capability, may be used as a layer on top of UDP.

Fax over IP is attractive to the extent it utilizes the installed base of fax machines and combines their utility with the low cost transmission of IP networks. However, the ability to send facsimile communications over Internet Protocol requires solving initial infrastructure incompatibilities between fax machines and IP networks.

Fax machines have critical timing protocols for certain portions of a example fax transmission. If the critical timing constraints are not met, the fax transmission aborts. Due to the timing constraints, FoIP first utilized a store and forward approach at the gateways. Each fax machine would converse with its respective gateway as if the gateway itself were a fax machine. The sending gateway would then transfer the fax events, in packets, to the receiving gateway. The receiving gateway would then remodulate the signal and converse with the receiving fax.

The current model, International Telecommunication Union—Telecommunication Standardization Sector (ITU-T) T.38 Procedures For Real-Time Group 3 Facsimile Communication Over IP Networks, June 1998, provides for substantially real-time fax over IP. In order to provide real-time FoIP, the strict timing constraints of facsimile communications must be managed in a packet switched network. Portions of the facsimile communication require a sufficient packet rate to preserve timing. The fax image transfer however, with less stringent timing constraints, is hampered by a high packet transfer rate because a significant amount of the transfer is overhead for the packets. Overhead for the packets consists of address information for IP, UDP, and UDPTL packets and error recovery, ordering information or redundancy information for TCP and UDPTL packets.

Presently, fax over IP utilizes the two technologies beneficially to lower cost, but the bandwidth can be more efficiently utilized. There is therefore a need to have a variable packet transfer rate that can provide high transfer rates to preserve timing where more stringently required in the fax communication yet also provide lower packet transfer rates, and larger packets, in the portion of the facsimile communication were timing is less restrictive and overhead can be decreased.

### BRIEF DESCRIPTION OF THE DRAWINGS

Embodiments of the invention are illustrated by way of example, and not necessarily by way of limitation in the figures of the accompanying drawings in which like reference numerals refer to similar elements.

FIG. 1 is an illustration of a typical facsimile communication.

FIG. 2 is an illustration of a T.38 facsimile communication.

FIG. 3A illustrates an IFP packet encapsulated in a TCP frame format.

FIG. 3B illustrates an IFP packet encapsulated in a UDPTL frame format.

FIG. 4 illustrates an IFP frame format.

FIG. 5 is a flowchart illustrating one embodiment of a variable packet rate facsimile over a packet switched network communication.

FIG. 6 is an illustration of one embodiment of a computing system capable of bandwidth optimization in modem over IP applications.

### DETAILED DESCRIPTION

A method and apparatus for a variable packet rate modem or facsimile communication over a packet switched network are disclosed. In this regard, an innovative facsimile over packet switched network service is introduced to facilitate efficiency control in these types of communications. In various embodiments the innovative facsimile over packet switched network service is implemented in a client computing device, a residential gateway, a network device and the like, to support facsimile over packet switched network services to remote facsimile machines.

In the following description numerous specific details are set forth in order to provide a thorough understanding of embodiments of the invention. It will be apparent, however, to one having ordinary skill in the art that the specific detail need not be employed to practice embodiments of the invention. In other instances, well known materials or methods have not been described in detail in order to avoid obscuring the present invention.

The apparatus may be specially constructed for the required purposes, or may comprise a general-purpose computer selectively activated or reconfigured by a computer program stored in a computer. Such a computer program may be stored in a machine-readable storage medium, such as, but not limited to, any type of magnetic or other disk storage media including floppy disks, optical storage media, CD-ROMs, and magnetic-optical disks, read-only memories (ROMs), random access memories (RAMs), EPROMs, EEPROMs, Flash memory, magnetic or optical cards; electrical, optical, acoustical or other form of propogated signals (e.g., carrier waves, infrared signals, digital signals, etc.), or any type of media suitable for storing electronic instructions, and each coupled to a computer system bus.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

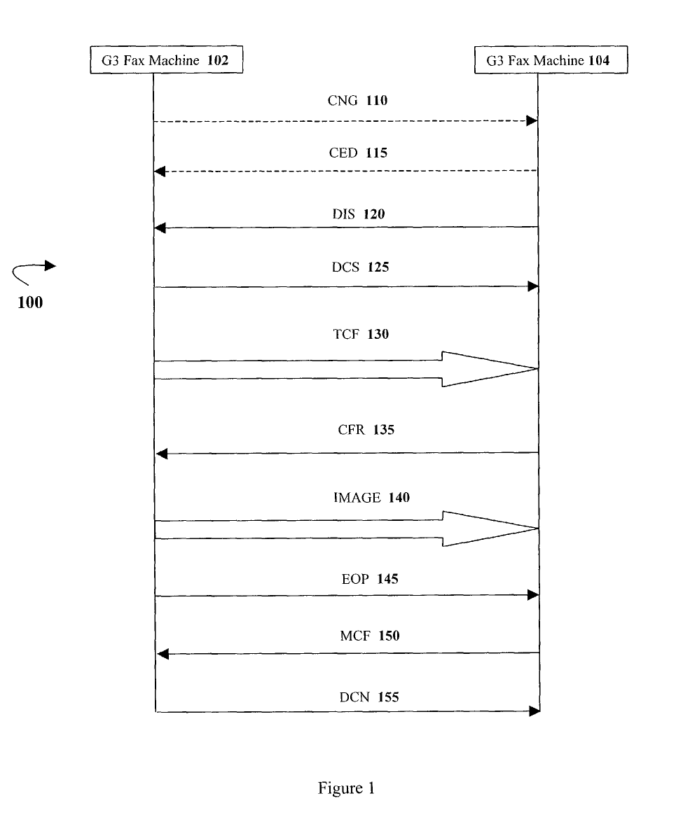

A conventional facsimile communication 100, complying with International Telecommunication Union—Telecommunication Standardization Sector (ITU-T) T.30 Procedures For Document Facsimile Transmission In The General Switched Telephone Network, April 1999, is illustrated in FIG. 1. The communication is representative of common signals that are communicated between two fax machines 102 and 104 while conducting a facsimile communication, although some of the signals may differ from those chosen in this illustration. The fax machine initiating the call is called the “sending” fax while the fax machine receiving the call is called the “receiving” fax. This clarification is important since both the sending fax machine and the receiving fax machine send and receive signals during a typical facsimile session. Fax machine or facsimile machine refers to any device or software conducting facsimile operations, even if the device is only a fax enabled device.

The initial stage of a facsimile communication generally contains two signals and is referred to as call establishment. A calling tone (CNG) 110, e.g. at 1100 Hz for 500 ms, is generated from a sending fax to indicate a fax call. A receiving fax initially replies with a called terminal identification tone (CED) 115, at 2100 Hz, in response to the fax call. These tones are primarily used to signal to a human participant that a fax machine is present.

The next stage of communications between facsimile machines is control and capabilities exchange. After the CED 115 reply tone, the receiving fax sends a Digital Identification Signal (DIS) 120 as part of the control and capabilities exchange portion of the fax transmission. The DIS 120 advertises the capabilities of the receiving fax to the sending fax. After receiving the DIS 120 the sending fax transmits a Digital Command Signal (DCS) 125, which advertises the capabilities to be used in the fax session. In order to determine the capabilities to advertise in the DCS 125, the sending fax must match its capabilities with those advertised in the DIS 120 from the receiving fax machine. The exchange of control messages, such as DIS and DCS as well as others described below are conducted using a low speed (300 bps) modulation rate.

Following transmission of the DCS 125 message, a high-speed modem training session, Training Check Field (TCF) 130, begins. A Training Check Field (TCF) 130 message sends a bit stream of zeros for 1.5 seconds to allow the receive fax to determine whether the telephone line quality is acceptable for the transmission of the fax image. A Confirmation To Receive message (CFR) 135 is sent from the receiving fax indicating the pre-message procedure is completed and that the fax image transfer may begin.

Following the transmission of CFR 135 the actual Image 140 is transmitted. The Image 140 is transmitted at the same high-speed modulation rate as the TCF training session. After the Image 140 is transmitted, an End Of Procedure (EOP) 145 signal is sent stating that transmission of the image is complete and (in this example) there are no further pages to send.

In response to the EOP 145 message, the receiving fax machine may send a Message Confirmation (MCF) 150. The MCF message indicates that the message has been successfully received. The sending fax, in response to the MCF, sends a Disconnect (DCN) 155 to signal termination of the fax session. No response is required to this message.

The TCF 130 and the Image 140 are transmitted at a higher modulation rate than the other communications. The other communications have more strict timing requirements that if not met will cause the facsimile transmission to abort. The nature of the TCF 130 and Image 140 transfer allow different treatment when sent over a packet switched network in order to optimize bandwidth. The fax transmission illustrated in FIG. 1 is an example fax transmission. Other types of messages may be sent instead of those illustrated. For instance when the receiving fax machine sends a DIS 120 to identify its capabilities, it may send a Called Subscriber Identification (CSI not shown in figure) which carries telephone number information about the called or calling party. Another signal that may be sent at the DIS 120 phase is a Non Standard Facilities (NSF not shown), which specifies capabilities of the fax machine not recognized by the ITU-T T.30 standard. Most signals shown if FIG. 1 have an alternate or additional signal that can occur at the same time. Reference to the ITU-T T.30 standard will reveal numerous different signals in Appendix I. FIG. 1 therefore is an example fax transmission simply showing signals of varying modulation rates and frequencies. FIG. 1 Illustrates different segments of a fax transmission along with different characteristics for these different segments.

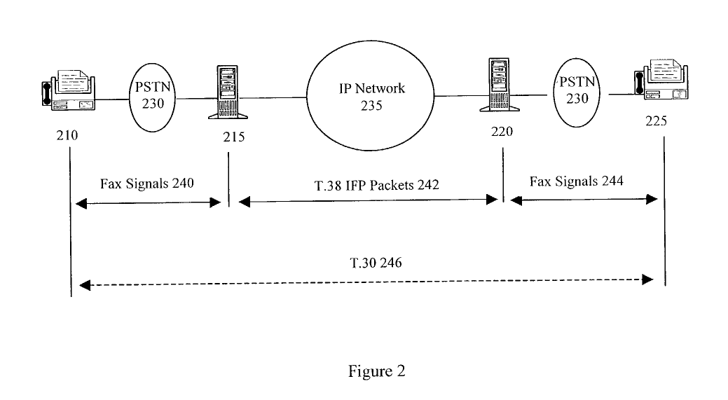

In FIG. 2, a schematic shows a fax transmission over an IP packet switched network abiding by International Telecommunication Union—Telecommunication Standardization Sector (ITU-T) T.38 Procedures For Real-Time Group 3 Facsimile Communication Over IP Networks, June 1998. It will be obvious to those skilled in the art that the benefits of embodiments of the invention can be realized in any packet switched network that allows a variable packet size or variable packet rate. It will also be obvious to those skilled in the art that the benefits of embodiments of the invention can be realized over any phone network that supports fax transmissions. The fax communication, as far as the fax machines are concerned, appears like a regular ITU recommendation T.30 facsimile transmission.

In reference to FIG. 2, a sending fax machine 210 sends signals through the Public Switched Telephone Network (PSTN) 230 to gateway 215. This embodiment shows the signals being sent through the PSTN 230, however, any phone system that can transmit a fax call may be used. The gateway 215 demodulates the fax signal and packetizes for transmission over the IP network 235. This embodiment shows an IP network; however, the gateway can be a gateway between any phone network and any packet switched network. In order to send the fax over the IP network, the gateway needs to know the address of the gateway 220. Once the address is determined, the packets are created and sent through the network 235. The gateway 220 remodulates the fax packets and communicates through the PSTN 230 to the receiving fax machine 225.

In further reference to FIG. 2, in a typical T.38 FoIP transmission, the sending fax 210 and gateway 215 communicate with fax signals 240 over a phone network 230. The gateway 215 and gateway 220 communicate with T.38 Internet Fax Protocol (IFP) packets 242 over the IP network 235. The gateway 220 and the receiving fax 225 communicate with fax signals 244 over the phone network 230. As previously mentioned, the end-to-end communication between the fax machines appears to each as a regular T.30 fax call 246.

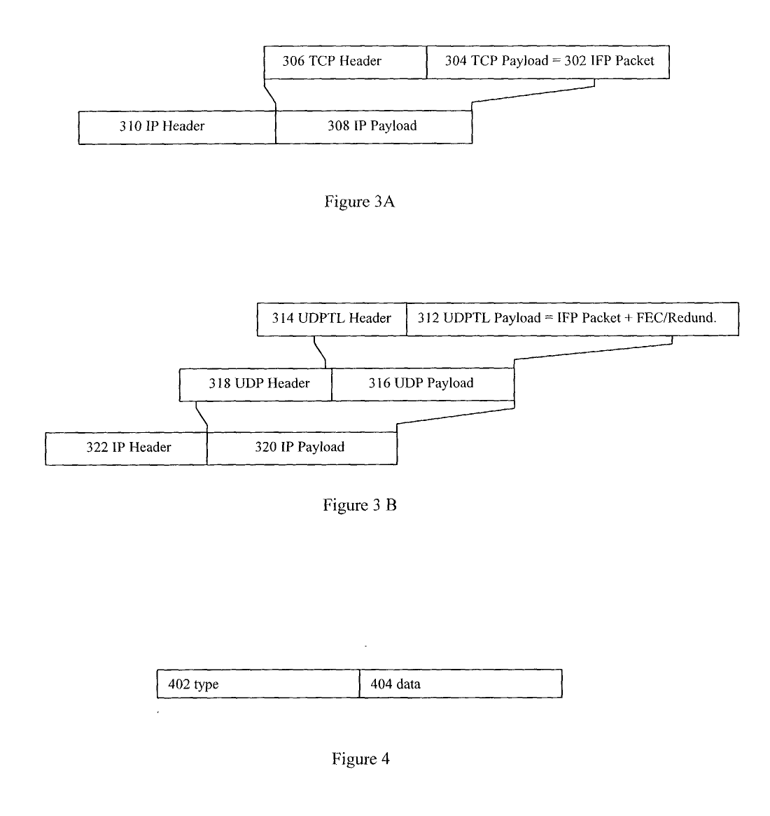

In reference to FIG. 3A, one embodiment shows a T.38 IFP packet 302 encapsulated as a TCP payload 304. To send this packet over an IP network a TCP header 306 is attached to the TCP payload 304, carrying the IFP packet 302, and together they are transported as IP payload 308 by appending an IP header 310 to the combined IP payload 308.

In reference to FIG. 3B, one embodiment shows a T.38 IFP packet encapsulated as a UDP Transport Layer (UDPTL) payload 312. This embodiment illustrates additional transport layer functionality in a UDP packet. For example, an error correction scheme such as Forward Error Correction (FEC), or packet redundancy, which will be represented in the UDPTL header to correct for the decreased quality of service offered by UDP in comparison to TCP. To send this packet over an IP network a UDPTL header 314 is attached to the UDPTL payload 312. The UDPTL information is then encapsulated as UDP payload 316 by the attachment of a UDP header 318. The UDP packet becomes IP payload 320 and is then sent over an IP network by appending an IP header 322.

IFP protocol is used to transfer fax signaling information and transfer data between gateways. Example IFP contents include signal detection, such as CNG 110, CED 115, V.21 preamble, high speed); T.30 protocol information, such as content of DIS 120 and DCS 125 frames; and TCF 130 training data and image 140 data.

According to the Abstract Syntax Notation One (ASN.1) in Annex A of ITU-T T.38, IFP packets are comprised of up to two fields, as shown in FIG. 4. A first field 402 is to identify the “type” of IFP packet as either t30-indicator or t30-data. A second field 404, if required, contains payload data. t30-indicator messages are used to indicate when fax signals have been detected. t30-data messages are used to transfer blocks of data, such as image data or High-Level Data Link Control (HDLC) formatted data.

IFP packets have a variable packet size that is determined by the IFP layer. A relationship between latency and packet size creates restrictions. If the IFP layer continues data collection for too long of a time period, protocols may time out. In one embodiment the IFP layer makes a determination based on the type of data to be sent. If the data is less subject to strict timing constraints or is a good candidate for overhead reduction, then the IFP layer accumulates data for a longer time before it generates a packet. In one embodiment packet generation can be slowed when the information to be sent comprises high speed data frames. Due to the numerous types of signals in T.30 fax communication, many scenarios exist for which packets to send at a slower packet rate or in a larger packet size.

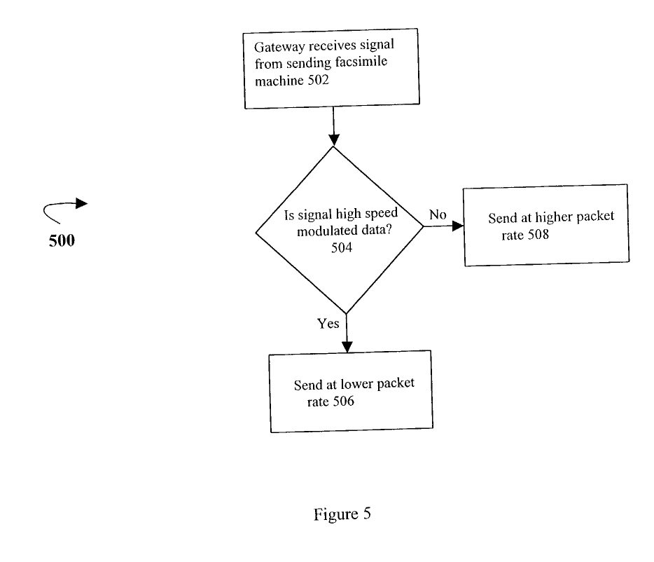

FIG. 5 is a flow chart 500 illustrating one embodiment of a process for overhead reduction in facsimile or modem over IP applications. At block 502 the gateway receives the signal from the sending facsimile machine. The gateway at block 502 may receive any modulated signal to be sent over a packet network.

In one embodiment, at block 504, the received signal in block 502 is determined to be either facsimile image data or otherwise. Block 504 represents one embodiment of a determination based on if the signal is high speed modulated data or not. Generally, block 504 represents a determination of whether the signal should be sent at one packet rate or another and the decision logic can be different. Other embodiments may make the determination based solely on if the signal is facsimile image data. If block 504 is true, which in one embodiment means that the signal is high speed modulated data, then it is sent at a lower packet rate as shown in block 506. In this embodiment if block 504 is false, then the signal is sent at a higher packet rate as shown in block 508.

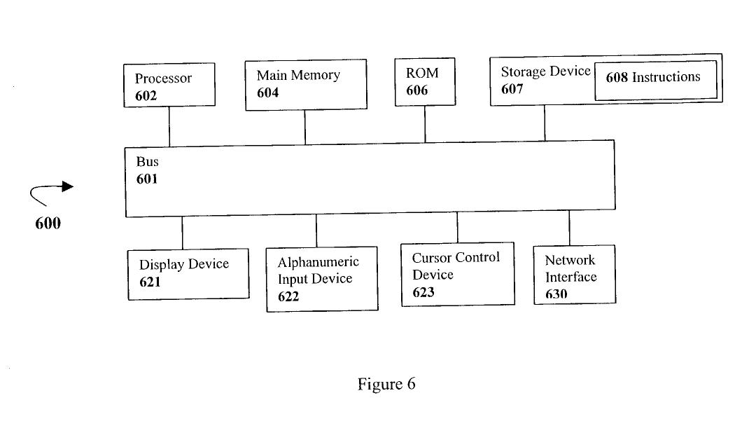

FIG. 6 is a block diagram of one embodiment of a computer system. Referring to FIG. 6, one embodiment may be an onramp or offramp gateway, or other computing system that converts modulated signals to packets and packets to modulated signals. The computer system illustrated in FIG. 6 is intended to represent a range of computer systems. Alternative computer systems can include more, fewer and/or different components.

Computer system 600 includes bus 601 or other communication device to communicate or transmit information, and processor 602 coupled to bus 601 to process information. Processor 602 may include semiconducting processors generally, ASICs, PLDs, FPGAs, DSPs, embedded processors, chipsets, or any other processing device. While computer system 600 is illustrated with a single processor, computer system 600 can include multiple processors and/or co-processors. Computer system 600 further includes random access memory (RAM) or other dynamic storage device 604 (referred to as main memory), coupled to bus 601 to store information and instructions to be executed by processor 602. Main memory 604 also can be used to store temporary variables or other intermediate information during execution of instructions by processor 602.

Computer system 600 also includes read only memory (ROM) and/or other static storage device 606 coupled to bus 601 to store static information and instructions for processor 602. Data storage device 607 is coupled to bus 601 to store information and instructions. Data storage device 607 such as a magnetic disk or optical disc and corresponding drive can be coupled to computer system 600.

Computer system 600 can also be coupled via bus 601 to display device 621, such as a cathode ray tube (CRT) or liquid crystal display (LCD), to display information to a computer user. Alphanumeric input device 622, including alphanumeric and other keys, is typically coupled to bus 601 to communicate information and command selections to processor 602. Another type of user input device is cursor control 623, such as a mouse, a trackball, or cursor direction keys to communicate direction information and command selections to processor 602 and to control cursor movement on display 621. Computer system 600 further includes network interface 630 to provide access to a network, such as a local area network.

Instructions are provided to memory from a storage device, such as magnetic disk, a read-only memory (ROM) integrated circuit, CD-ROM, DVD, via a remote connection (e.g., over a network via network interface 630) that is either wired or wireless, etc. In alternative embodiments, hard-wired circuitry can be used in place of or in combination with software instructions to implement embodiments of the invention. Thus, the present invention is not limited to any specific combination of hardware circuitry and software instructions.

A machine-accessible medium includes any mechanism that provides (i.e., stores and/or transmits) information in a form readable by a machine (e.g., a computer). For example, a machine-accessible medium includes read only memory (ROM); random access memory (RAM); magnetic disk storage media; optical storage media; flash memory devices; electrical, optical, acoustical or other form of propagated signals (e.g., carrier waves, infrared signals, digital signals); etc.

In one embodiment a storage medium 607 including executable content or instructions 608 is connected to control logic in the processor 602 to selectively access and execute the content 608 to implement a facsimile over network protocol service, an example being FoIP, to send portions of the facsimile communication at one packet rate and to send other portions of the facsimile communication at another packet rate. It will be obvious to one skilled in the art to configure a gateway or fax enabled device to decrease overhead in, for example, the fax image 140 transfer or the TCF 130 message by having the gateway or fax enabled device fill the IFP packet with more data than other types of signals. The determination of which portions of the fax communication to send at a higher packet rate are determined by the requirements of specific implementations.

In the foregoing detailed description, the method and apparatus of embodiments of the invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

1. A method of sending a facsimile through an internetwork comprising:
sending at least one of control and capabilities exchange messages at a first packet rate; and
sending facsimile image data at a second packet rate.

2. The method of claim 1 wherein the facsimile image data is sent at a slower packet rate.

3. The method of claim 1 wherein the internetwork is an internet protocol internetwork.

4. A method for sending a facsimile over a network protocol comprising:
sending at least one of a tone event, signal detect event, and low speed modulated data at a first packet rate; and
sending high speed modulated data at a second packet rate.

5. The method of claim 4 wherein the high speed modulated data is sent at a slower packet rate.

6. The method of claim 4 wherein the network protocol is internet protocol.

7. A method for sending a facsimile over a network protocol comprising:
sending at least one of a tone event, signal detect event, and low speed modulated data at a first packet rate; and
sending facsimile image data at a second packet rate.

8. The method of claim 7 wherein the facsimile image data is sent at a slower packet rate.

9. The method of claim 7 wherein the network protocol is internet protocol.

10. A method for sending a facsimile over an internetwork comprising:
sending at least one of a tone event, signal detect event, and low speed modulated data in a first packet size; and
sending facsimile image data in a second packet size.

11. The method of claim 10 wherein the second packet size is larger than the first packet size.

12. The method of claim 10 wherein the internetwork is an internet protocol internetwork.

13. A machine-readable medium having stored thereon data representing sequences of instructions which, when executed by a processor, cause the processor to perform operations comprising:
sending at least one of a tone event, signal detect event, and low speed modulated data at a first packet rate; and
sending facsimile image data at a second packet rate.

14. The medium of claim 13 wherein the facsimile image data is sent at a slower packet rate.

15. The medium of claim 13 wherein the network protocol is internet protocol.

16. A computing appliance comprising:
a storage medium including executable content;
a control logic, coupled with the storage medium to selectively access and execute the content to implement a facsimile over Internet Protocol (FOIP) service to send at least one of a tone event, signal detect event, and low speed modulated data at a first packet rate; and
to send facsimile image data at a second packet rate.

17. A computing system according to claim 16, further comprising an input port, to receive facsimile image data from a remote computing appliance.

18. A computing appliance according to claim 17 further comprising an output port, coupled to a circuit switched network gateway to send the data packets to a target fax.
